(19) United States
(12) Patent Application Publication
(10) Pub. No.: US 2020/0250638 A1
(43) Pub. Date: Aug. 6, 2020

(54) Hybrid Unique Identifiable Currency

(71) Applicant: Ryan Johnson, Riverside, CA (US)

(72) Inventor: Ryan Johnson, Riverside, CA (US)

(21) Appl. No.: 16/779,489

(22) Filed: Jan. 31, 2020

Related U.S. Application Data
(60) Provisional application No. 62/800,469, filed on Feb. 2, 2019.

(51) Int. Cl. G06Q 20/10; G06Q 20/06; G06Q 20/36

(52) U.S. Cl. CPC G06Q 20/105; G06Q 20/3672; G06Q 20/3678; G06Q 20/0658

(57) ABSTRACT

A hybrid method of electronic and physical currency that comprises an issuer who issues individual physical currency that is additionally represented in an electronic registry. The physical currency is electronically verified by a merchant at the time of purchase to insure that electronic indicators and verifications match that of its corresponding registry indicators. The consumer can elect to register their own currency for security purposes. The currency's purchasing power can also be limited to specific goods for charity purposes.

### BACKGROUND OF THE INVENTION

This invention relates to a hybrid physical and electronic currency purchasing system for the purpose of security, safety, anonymity, traceability, and consistency.

There are presently three major methods of payment used today; electronic cash or credit, physical cash (example: coins and paper money), and commodity money (items with intrinsic value such as gold and silver). Each of these methods have their own shortcomings.

Physical cash is simplistic and anonymous form of payment. But these traits also encourage illicit conduct. Cash can be used to purchase illegal drugs or weapons, it can be stolen without a trace, and can be used to encourage corrupt conduct such as bribery or unregulated business conduct. Physical cash is also susceptible to counterfeit. Disingenuous individuals and non-profits that solicit charity can use the money against the intentions of their donors. Additionally physical cash can be created without being accounted for or recorded. This lack of transparency limits its strength to trade with the currency of other parties. For example a country can print money to pay off debt to another country there by lowering the actual value of their payment. Some physical currencies do use unique identifiers but they're not used in common practice as a necessity of purchase and the identifiers aren't typically used for fast electronic reading.

Commodity money (Items with intrinsic value example: gold, silver, or crystals) has nearly all the same problems as cash. It's beneficial in regards that it has an intrinsic value in relation to international exchange but this can also be a problem as well. The value of commodity money fluctuates as its intrinsic value changes. This causes a different type of uncertainty in the market that doesn't accurately reflect the prosperity of an economy.

Electronic cash or credit addresses some of these issues but introduces challenges of its own. Traceability can limit some of the under the table practices and illicit conduct. But this can also foster it with anonymous transactions. Unfortunately electronic money can be stolen wirelessly. It also deprives the consumer of their privacy. If the money is electronically counterfeited the thieves do not have to overcome the barriers of creating individual physical currency. Electronic money is also at the mercy of the electronic infrastructure supporting it. So if the computers or internet are down or corrupted the effect is more devastating. To that same respect there are challenges when infrastructure isn't initially in place. Or if you wanted to give money to another individual for reasons such as shared purchases or helping a homeless individual. Electronic money is also arguably limiting for the purpose of for foreign currency because it doesn't have a tangible item to exchange.

### BRIEF SUMMARY OF THE INVENTION

Accordingly there needs to be a currency and payment system that allows for the security and privacy provided by physical currency but also utilizes the methods of electronic currency that discourages corrupt or illicit conduct. Additionally the solution needs to reduce its susceptibility to counterfeit and theft. The proposed invention is a hybrid currency and method of payment system which utilizes the advantages both physical cash and electronic payment systems. The need of physical currency that is further validated with an electronic registry, in order to purchase goods and services, aids in the prevention of counterfeit and theft. The Physical currency allows for a secondary security in the event computers are compromised. The option of registry allows for a system of privacy. The option for authorities to electronically mark currency aides in monitoring and discouraging elicit conduct. Illicit conduct can be further limited by having types of currency that are prohibited from purchasing predetermined items (for example: Drugs, weapons, etc.). This allows for such currency to be idealistic for donations, or for use of specific causes (example: government projects, feeding programs, etc.).

The following description and corresponding illustrations may be best to describe the key solutions of the invention.

### BRIEF DESCRIPTION OF DRAWINGS

FIG. 1 Depicts a transaction process and practice in which the invention is used as a primary currency.

FIG. 2 Depicts another process in which the invention could be practiced for a one time purchase. It differs from FIG. 1 in that the proposed currency would reimburse by a primary currency

FIG. 3 Illustrates parts of a single note of currency that could be used in the process protected by this invention.

### DETAILED DESCRIPTION OF THE INVENTION

An issuer (1a) can be a Bank, business, government entity, country, state, foreign entity, global organization etc or combination thereof; who issues the currency. Upon receiving currency, a consumer (2a) has the ability to register individual notes to an account that they have with an issuer. Unregistered notes can be used for purchases or even voluntarily given to other consumers (2b). This can be a friend, family member, charity, etc. Once a note is registered it can only be used for a purchase if a predetermined authentication of that consumer is present (for example: Identification, pin number, etc) at the time of purchase. Upon such a transaction the registration of such a note would be transferred to the merchant. Notes can also be registered by authorities (example: police, military, etc) to mark them and prevent illegal conduct. These actions disincentive stealing money from individuals as thieves can be tracked.

A merchant (3a) is simply an entity providing goods and or services in exchange for the currency described in this application. When a consumer gives a merchant currency for goods and services the merchant reads each note electronically. This data is sent electronically to the issuer for authentication. The issuer can verify that the notes aren't registered with another individual or organization. If the note is registered with the present consumer, he or she will need to provide a predetermined verification (example ID, pin number, issuer assigned chip, etc) in order to use that note for the purchase.

At minimum each individual currency will have a unique identifier but there can be additional information that can be sent to other locations for additional authorization (4b). Additional authorization can be done by a third party or simply a different database owned by the issuer. Different parts of the information, read from each note can, be assigned for verification to different parties to authorize. The separation of the two further limits vulnerability from threats such as cyberattacks.

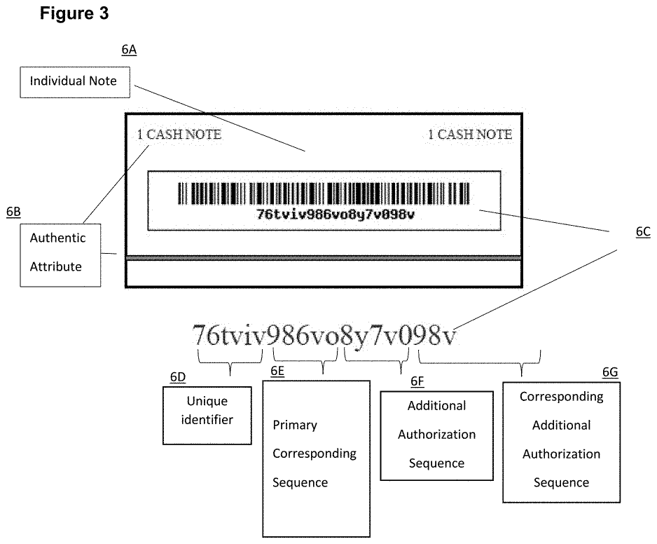

FIG. 3 depicts one possible embodiment of this authentication. The unique identifier (6D) is shared with all parties, the Primary Corresponding Sequence is sent to the issuer who verifies that it is the appropriate sequence (4a). An additional authorization sequence (6F) can be sent to an additional authorizer with a (6G) corresponding sequence to be verified. There can be any number of addition authorization (4b) parties and any number of sequences and corresponding sequences to be verified; further increasing security.

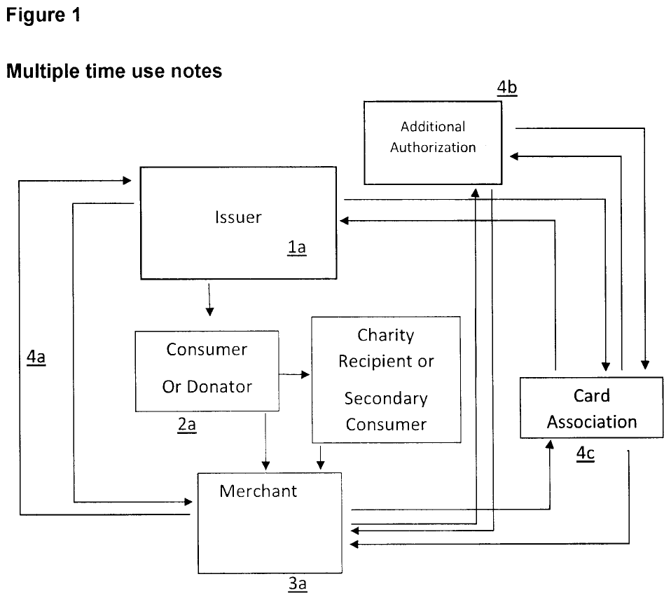

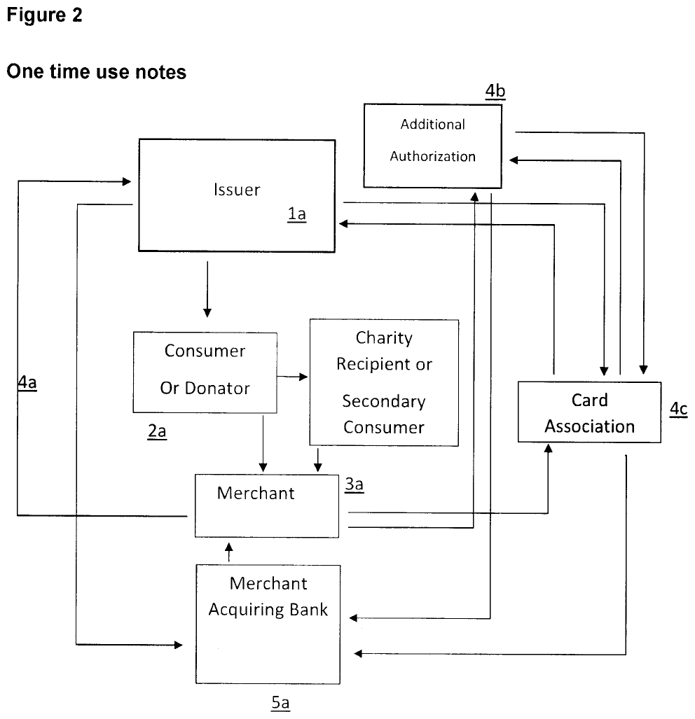

FIG. 1 and FIG. 2 both include a card association (4c). Many businesses already use services such as Visa, Master Card, American Express, etc. Because of this it may be more cost and time effective for an issuer to use their established systems to mediate verification through merchants as opposed to the merchants sending the currency data directly to the issuer. Likewise the issuer could also arrange to have the card association act as an addition authorization (4b).

Once the currency has been validated and the consumer has transferred registration the transaction is complete. If the currency is used as the primary currency, such as the nationally accepted currency, then the merchant can use the notes as money. If the notes are being used as a script currency, as depicted in FIG. 2, then the validation would be sent to the merchant's acquiring bank (5a) and government back currency would be transferred into the merchant's account from the issuer. The entire process would be instantaneous.

FIG. 3 illustrates one embodiment of a single note used as currency outlined in this invention. Physical note:

The inventor presently contemplates that each bank note be made of paper but the note can be made of any material or combination of materials such as cotton, linen, metal, glass, synthetic material, biological material, intrinsic medals, plastics, carbon, crystals, diamonds etc. The inventor presently contemplates that each bank note measure 2.5 by 6 inches and be roughly the thickness of paper however each note can be made of any material and be any size shape and dimensions such as triangular, spherical, oblong, modular, etc. Currently issued government money can also be used so long as it has a unique identifier that can be read by a machine so that it can be electronically validated and registered.

Each note would have a minimum of a machine readable unique identifier (6D) but could also additionally have multiple corresponding machine-readable identifiers (6D, 6E, 6F, and 6G). The inventor presently contemplates that each unique identifier and corresponding identifier be represented by bar codes however they can be represented by any entity or combination of entities such as QR code, RFID, varying types of inks, genetic sequences, radioactive material, electronic chip, weight, varying transparency, holograms, etc. There can be any number of identifiers and corresponding sequences on each note and can be represented by any number or combination of ways.

6B depicts items that will add authenticity to the physical note. Each note can, in addition to the security measures of this patent, include security measures such as, but not limited to; built in water marks, security thread, security ribbon, color shifting ink, metal ink, RFID, specific weight, UV verification, portraits, vignettes, scrollwork, numerals, lettering, and other art work, holograms, radio activity, magnetic capabilities, etc.

In the event a merchant cannot validate notes electronically they can still choose to accept them at their discretion. This lowers the impact of events where electronic authorization is not possible such as cyberattacks, power outages, technical difficulties, etc. The merchant will incur any illegitimacies in the money they accept so this is not an ideal common practice.

Notes can also be made or registered specifically for the purpose of charity. Such notes cannot be used for purposes such as abusive substances or weapons.

What is claimed is:

1. A method of currency or payment using a hybrid of electronic and physical medium of exchange to purchase goods and services that comprises:
At least one issuer of currency comprising or interfacing with at least one registry of at least one unique identifier;
At least one physical currency comprising a replication of at least one said unique identifier sequence from said registry;
At least one consumer to receive and exchange or donate at least one said physical currency;
At least one merchant to electronically confirm said replicated unique identifier with that of original currency note sequence in said registry as to support the legitimization of said physical currency in exchange for goods and or services where by utilizing the benefits of both the physical and electronic forms of exchange.

2. The method as recited in claim 1, wherein the exchange of said physical currency for abusive substances and or weapons and or other predetermined services or materials may be prohibited by the issuer, merchant, or other entity.

3. The method as recited in claim 1, wherein the issuer comprises or interfaces with at least one registry of said consumers in which said consumer can elect to register one or more of their said physical currency to themselves to proclaim ownership or transfer their previously registered currency to other consumers or merchants in registry.

4. The method as recited in claim 3, wherein said registered note would need additional verification present during purchase in order to validate the consumer's ownership of registered to said merchant.

5. The method as recited in claim 1, wherein at least one said unique identifier is electable by at least one law enforcement entity to be electronically marked in order to monitor potential illicit conduct.

6. The method as recited in claim 1, wherein at least one said physical currency would comprise at least one additional authorization sequence and or corresponding authorization sequence that would need to be validated with at least one additional authorization sequence and or corresponding authorization sequence that is comprised in at least one separate registry.

7. The method as recited in claim 1, wherein the said physical currency comprises at least one material and or at least one item of intrinsic value.

8. The method as recited in claim 1, wherein said registry is represented by blockchain.
